(19) United States
(12) Patent Application Publication
(10) Pub. No.: US 2016/0381678 A1
(43) Pub. Date: Dec. 29, 2016

(54) RESOURCE ALLOCATION METHOD AND BASE STATION CONTROLLER

(71) Applicant: HUAWEI TECHNOLOGIES CO.,LTD., Shenzhen (CN)

(72) Inventors: Jia He, Chengdu (CN); Ziming Yu, Chengdu (CN); Miaomiao Zhang, Shenzhen (CN)

(73) Assignee: HUAWEI TECHNOLOGIES CO.,LTD., Shenzhen (CN)

(21) Appl. No.: 15/263,097

(22) Filed: Sep. 12, 2016

Related U.S. Application Data
(63) Continuation of application No. PCT/CN2014/091938, filed on Nov. 21, 2014.

(30) Foreign Application Priority Data
Mar. 12, 2014 (CN) 201410091149.5

(51) Int. Cl. H04W 72/04

(52) U.S. Cl. CPC H04W 72/0433; H04W 72/0486; H04W 72/0493; H04W 88/12

(57) ABSTRACT

The present disclosure provides a resource allocation method and a base station controller, which can improve resource utilization. The method includes receiving reference signals sent by all active user equipment in a first sector during a current listening period, determining the all active user equipment according to the reference signals; acquiring total data traffic of the first sector during the current listening period according to the all active user equipment; determining a to-be-adjusted resource quantity of an access antenna and a to-be-adjusted resource quantity of a backhaul antenna in resources of the base station antenna according to the total data traffic of the first sector during the current listening period; generating control information; and sending the control information to the base station antenna. The present disclosure is applied to resource allocation of a base station antenna.

### CROSS REFERENCE

This application is a continuation of International Application No. PCT/CN2014/091938, filed on Nov. 21, 2014, which claims priority to Chinese Patent Application No. 201410091149.5, filed on Mar. 12, 2014, both of which are incorporated herein by reference in their entireties.

### TECHNICAL FIELD

The present disclosure relates to the communications field, and in particular, to a resource allocation method and a base station controller.

### BACKGROUND

In a broad sense, a base station is short for a BSS (base station subsystem), including a base station controller and a base station antenna. The base station antenna is classified into three types of antennas: an access antenna, a backhaul antenna, and a listening antenna. The listening antenna is used to receive, during a listening period, a reference signal sent by user equipment, so as to detect a reference signal of active user equipment and determine a position of an active user. The access antenna and the backhaul antenna are antennas used to perform service communication, where an access antenna is an antenna used to perform service communication between a base station and a user, and the backhaul antenna is an antenna used to perform data transmission between base stations.

### SUMMARY

Embodiments of the present disclosure provide a resource allocation method and a base station controller, which can improve resource utilization.

To achieve the foregoing objective, the following technical solutions are used in the embodiments of the present disclosure:

According to a first aspect, a base station controller is provided that includes a receiver, configured to receive reference signals sent by all active user equipment in a first sector during a current listening period, where the first sector is any sector of a base station antenna in a base station in which the base station controller is located, a processor coupled to the receiver, configured to determine the all active user equipment according to the reference signals, acquire total data traffic of the first sector during the current listening period according to the all active user equipment, determine a to-be-adjusted resource quantity of an access antenna and a to-be-adjusted resource quantity of a backhaul antenna in resources of the base station antenna according to the total data traffic of the first sector during the current listening period, generate control information, where the control information includes the to-be-adjusted resource quantity of the access antenna and the to-be-adjusted resource quantity of the backhaul antenna, and a transmitter coupled to the processor, configured to send the control information to the base station antenna, where the control information includes the to-be-adjusted resource quantity of the access antenna and the to-be-adjusted resource quantity of the backhaul antenna, so that the base station antenna adjusts a resource of the access antenna and a resource of the backhaul antenna according to the control information.

With reference to the first aspect, in a first implementable manner, an initial resources of the base station antenna are allocated according to a preset proportion of the access antenna, the backhaul antenna, and a listening antenna.

With reference to the first implementable manner, in a second implementable manner, a parameter of the listening antenna is preset by the base station controller, and the parameter of the listening antenna includes a beam width, a beam angle, a listening period, and listening time that are of the listening antenna.

With reference to the second implementable manner, in a third implementable manner there is a processor configured to acquire preset average data traffic of the first sector, determine whether the total data traffic of the first sector during the current listening period is greater than the preset average data traffic of the first sector, acquire a preset peak value of the first sector if the total data traffic of the first sector during the current listening period is greater than the preset average data traffic of the first sector, determine whether the total data traffic of the first sector during the current listening period is greater than the preset peak value of the first sector, acquire total data traffic of the first sector during a previous listening period if the total data traffic of the first sector during the current listening period is greater than the preset peak value of the first sector, determine whether the total data traffic of the first sector during the previous listening period is greater than the preset peak value of the first sector, and send a cooperative work request to another base station if the total data traffic of the first sector during the previous listening period is less than or equal to the preset peak value of the first sector, so that the another base station performs information transmission with user equipment in the first sector according to the cooperative work request.

With reference to the third implementable manner, in a fourth implementable manner the processor is further configured to acquire the total data traffic of the first sector during the previous listening period if the total data traffic of the first sector during the current listening period is less than or equal to the preset peak value of the first sector, determine whether the total data traffic of the first sector during the previous listening period is greater than the preset peak value of the first sector, if the total data traffic of the first sector during the previous listening period is greater than the preset peak value of the first sector, send a cooperative stop request to another base station, so that the another base station stops performing information transmission with user equipment in the first sector according to the cooperative stop request, obtain a corresponding to-be-decreased resource quantity of the backhaul antenna and a corresponding to-be-increased resource quantity of the access antenna according to a traffic difference between the total data traffic of the first sector during the current listening period and the preset average data traffic of the first sector, and if the total data traffic of the first sector during the previous listening period is less than or equal to the preset peak value of the first sector, obtain a corresponding to-be-decreased resource quantity of the backhaul antenna and a corresponding to-be-increased resource quantity of the access antenna according to a traffic difference between the total data traffic of the first sector during the current listening period and the preset average data traffic of the first sector.

With reference to the third implementable manner, in a fifth implementable manner, the processor is further configured if the total data traffic of the first sector during the current listening period is less than or equal to the preset average data traffic of the first sector, obtain a corresponding to-be-increased resource quantity of the backhaul antenna and a corresponding to-be-decreased resource quantity of the access antenna according to a traffic difference between the total data traffic of the first sector during the current listening period and the preset average data traffic of the first sector.

With reference to the fifth implementable manner, in a sixth implementable manner, the processor is further configured to acquire a total quantity of the all active user equipment, determine whether the total quantity of the all active user equipment is 0, and if the total quantity of the all active user equipment is 0, send, to the base station antenna, a disabling indication used to instruct to disable all access antennas in the first sector.

According to a second aspect, a resource allocation method is provided and is applied to a base station controller, including receiving reference signals sent by all active user equipment in a first sector during a current listening period, where the first sector is any sector of a base station antenna in a base station in which the base station controller is located, determining the all active user equipment according to the reference signals, acquiring total data traffic of the first sector during the current listening period according to the all active user equipment, determining a to-be-adjusted resource quantity of an access antenna and a to-be-adjusted resource quantity of a backhaul antenna in resources of the base station antenna according to the total data traffic of the first sector during the current listening period, generating control information, where the control information includes the to-be-adjusted resource quantity of the access antenna and the to-be-adjusted resource quantity of the backhaul antenna, and sending the control information to the base station antenna, where the control information includes the to-be-adjusted resource quantity of the access antenna and the to-be-adjusted resource quantity of the backhaul antenna, so that the base station antenna adjusts a resource of the access antenna and a resource of the backhaul antenna according to the control information.

With reference to the second aspect, in a first implementable manner, before the determining a to-be-adjusted resource quantity of an access antenna and a to-be-adjusted resource quantity of a backhaul antenna in resources of the base station antenna according to the total data traffic of the first sector during the current listening period, an initial resources of the base station antenna are allocated according to a preset proportion of the access antenna, the backhaul antenna, and a listening antenna.

With reference to the first implementable manner, in a second implementable manner, a parameter of the listening antenna is preset by the base station controller, and the parameter of the listening antenna includes a beam width, a beam angle, a listening period, and listening time that are of the listening antenna.

With reference to the second implementable manner, in a third implementable manner, the determining a to-be-adjusted resource quantity of an access antenna and a to-be-adjusted resource quantity of a backhaul antenna in resources of the base station antenna according to the total data traffic of the first sector during the current listening period includes acquiring preset average data traffic of the first sector, determining whether the total data traffic of the first sector during the current listening period is greater than the preset average data traffic of the first sector, acquiring a preset peak value of the first sector if the total data traffic of the first sector during the current listening period is greater than the preset average data traffic of the first sector, determining whether the total data traffic of the first sector during the current listening period is greater than the preset peak value of the first sector, acquiring total data traffic of the first sector during a previous listening period if the total data traffic of the first sector during the current listening period is greater than the preset peak value of the first sector, determining whether the total data traffic of the first sector during the previous listening period is greater than the preset peak value of the first sector, and sending a cooperative work request to another base station if the total data traffic of the first sector during the previous listening period is less than or equal to the preset peak value of the first sector, so that the another base station performs information transmission with user equipment in the first sector according to the cooperative work request.

With reference to the third implementable manner, in a fourth implementable manner, after the determining whether the total data traffic of the first sector during the current listening period is greater than the preset peak value of the first sector, the determining a to-be-adjusted resource quantity of an access antenna and a to-be-adjusted resource quantity of a backhaul antenna in resources of the base station antenna according to the total data traffic of the first sector during the current listening period, further includes acquiring the total data traffic of the first sector during the previous listening period if the total data traffic of the first sector during the current listening period is less than or equal to the preset peak value of the first sector, determining whether the total data traffic of the first sector during the previous listening period is greater than the preset peak value of the first sector, if the total data traffic of the first sector during the previous listening period is greater than the preset peak value of the first sector, sending a cooperative stop request to another base station, so that the another base station stops performing information transmission with user equipment in the first sector according to the cooperative stop request, obtaining a corresponding to-be-decreased resource quantity of the backhaul antenna and a corresponding to-be-increased resource quantity of the access antenna according to a traffic difference between the total data traffic of the first sector during the current listening period and the preset average data traffic of the first sector, and if the total data traffic of the first sector during the previous listening period is less than or equal to the preset peak value of the first sector, obtaining a corresponding to-be-decreased resource quantity of the backhaul antenna and a corresponding to-be-increased resource quantity of the access antenna according to a traffic difference between the total data traffic of the first sector during the current listening period and the preset average data traffic of the first sector.

With reference to the third implementable manner, in a fifth implementable manner, after the determining whether the total data traffic of the first sector during the current listening period is greater than the preset average data traffic of the first sector, the resource allocation method further includes if the total data traffic of the first sector during the current listening period is less than or equal to the preset average data traffic of the first sector, obtaining a corresponding to-be-increased resource quantity of the backhaul antenna and a corresponding to-be-decreased resource quantity of the access antenna according to a traffic difference between the total data traffic of the first sector during the current listening period and the preset average data traffic of the first sector.

With reference to the fifth implementable manner, in a sixth implementable manner, after the determining the all active user equipment according to the reference signals, the resource allocation method further includes acquiring a total quantity of the all active user equipment, determining whether the total quantity of the all active user equipment is 0, and if the total quantity of the all active user equipment is 0, sending, to the base station antenna, a disabling indication used to instruct to disable all access antennas in the first sector.

The embodiments of the present disclosure provide a resource allocation method and a base station controller. The method includes: receiving reference signals sent by all active user equipment in a first sector during a current listening period, where the first sector is any sector of a base station antenna in a base station in which the base station controller is located; determining the all active user equipment according to the reference signals; acquiring total data traffic of the first sector during the current listening period according to the all active user equipment; determining a to-be-adjusted resource quantity of an access antenna and a to-be-adjusted resource quantity of a backhaul antenna in resources of the base station antenna according to the total data traffic of the first sector during the current listening period; generating control information, where the control information includes the to-be-adjusted resource quantity of the access antenna and the to-be-adjusted resource quantity of the backhaul antenna; and sending the control information to the base station antenna. In this way, a base station controller may adjust a resource quantity of the access antenna and a resource quantity of the backhaul antenna according to a total quantity of active user equipment during the current listening period and the total data traffic of the first sector during the current listening period, which improves resource utilization of the base station antenna and saves resources of the base station.

### BRIEF DESCRIPTION OF DRAWINGS

To describe the technical solutions in the embodiments of the present disclosure more clearly, the following briefly introduces the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a schematic structural diagram of a base station controller according to an embodiment of the present disclosure;

FIG. 2 is a schematic structural diagram of another base station controller according to an embodiment of the present disclosure;

FIG. 3 is a schematic structural diagram of still another base station controller according to an embodiment of the present disclosure;

FIG. 4 is a flowchart of a resource allocation method according to an embodiment of the present disclosure; and

FIG. 5 is a flowchart of another resource allocation method according to an embodiment of the present disclosure.

### DESCRIPTION OF EMBODIMENTS

The following clearly describes the technical solutions in the embodiments of the present disclosure with reference to the accompanying drawings in the embodiments of the present disclosure. Apparently, the described embodiments are merely some but not all of the embodiments of the present disclosure. All other embodiments obtained by a person of ordinary skill in the art based on the embodiments of the present disclosure without creative efforts shall fall within the protection scope of the present disclosure.

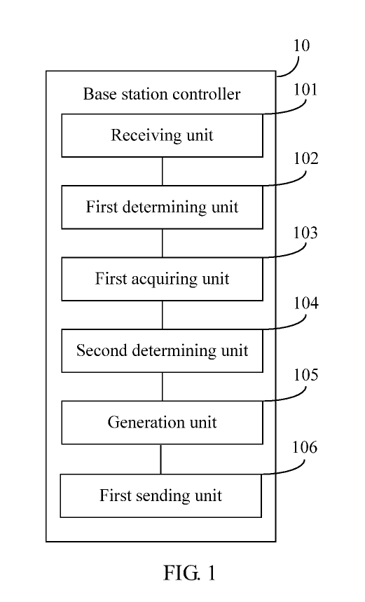

As shown in FIG. 1, an embodiment of the present disclosure provides a base station controller 10 that includes a receiving unit 101, configured to receive reference signals sent by all active user equipment in a first sector during a current listening period, where the first sector is any sector of a base station antenna in a base station in which the base station controller is located, a first determining unit 102, configured to determine the all active user equipment according to the reference signals, a first acquiring unit 103, configured to acquire total data traffic of the first sector during the current listening period according to the all active user equipment, a second determining unit 104, configured to determine a to-be-adjusted resource quantity of an access antenna and a to-be-adjusted resource quantity of a backhaul antenna in resources of the base station antenna according to the total data traffic of the first sector during the current listening period. A parameter of a listening antenna is preset by the base station controller, and the parameter of the listening antenna includes a beam width, a beam angle, a listening period, and listening time that are of the listening antenna, a generation unit 105, configured to generate control information, where the control information includes the to-be-adjusted resource quantity of the access antenna and the to-be-adjusted resource quantity of the backhaul antenna, and a first sending unit 106, configured to send the control information to the base station antenna, where the control information includes the to-be-adjusted resource quantity of the access antenna and the to-be-adjusted resource quantity of the backhaul antenna, so that the base station antenna adjusts a resource of the access antenna and a resource of the backhaul antenna according to the control information.

In this way, a base station console may adjust a resource quantity of the access antenna and a resource quantity of the backhaul antenna according to a total quantity of active user equipment during the current listening period and the total data traffic of the first sector during the current listening period, which improves resource utilization of the base station antenna and saves resources of the base station.

The initial resources of the base station antenna are allocated according to a preset proportion of the access antenna, the backhaul antenna, and the listening antenna. Each base station antenna can allocate resources to both an access antenna and a backhaul antenna, instead of only the access antenna or the backhaul antenna. Therefore, resources of the base station antenna are saved, and the access antenna and the backhaul antenna are located at a same base station, which implements integration of the base station antenna.

The second determining unit 104 is specifically configured to acquire preset average data traffic of the first sector, determine whether the total data traffic of the first sector during the current listening period is greater than the preset average data traffic of the first sector, acquire a preset peak value of the first sector if the total data traffic of the first sector during the current listening period is greater than the preset average data traffic of the first sector, determine whether the total data traffic of the first sector during the current listening period is greater than the preset peak value of the first sector, acquire total data traffic of the first sector during a previous listening period if the total data traffic of the first sector during the current listening period is greater than the preset peak value of the first sector, determine whether the total data traffic of the first sector during the previous listening period is greater than the preset peak value of the first sector, and send a cooperative work request to another base station if the total data traffic of the first sector during the previous listening period is less than or equal to the preset peak value of the first sector, so that the another base station performs information transmission with user equipment in the first sector according to the cooperative work request.

Further, the second determining unit 104 is further configured to acquire the total data traffic of the first sector during the previous listening period if the total data traffic of the first sector during the current listening period is less than or equal to the preset peak value of the first sector, determine whether the total data traffic of the first sector during the previous listening period is greater than the preset peak value of the first sector, if the total data traffic of the first sector during the previous listening period is greater than the preset peak value of the first sector, send a cooperative stop request to another base station, so that the another base station stops performing information transmission with user equipment in the first sector according to the cooperative stop request, obtain a corresponding to-be-decreased resource quantity of the backhaul antenna and a corresponding to-be-increased resource quantity of the access antenna according to a traffic difference between the total data traffic of the first sector during the current listening period and the preset average data traffic of the first sector, and if the total data traffic of the first sector during the previous listening period is less than or equal to the preset peak value of the first sector, obtain a corresponding to-be-decreased resource quantity of the backhaul antenna and a corresponding to-be-increased resource quantity of the access antenna according to a traffic difference between the total data traffic of the first sector during the current listening period and the preset average data traffic of the first sector.

Further, the second determining unit 104 are further used to, if the total data traffic of the first sector during the current listening period is less than or equal to the preset average data traffic of the first sector, obtain a corresponding to-be-increased resource quantity of the backhaul antenna and a corresponding to-be-decreased resource quantity of the access antenna according to a traffic difference between the total data traffic of the first sector during the current listening period and the preset average data traffic of the first sector.

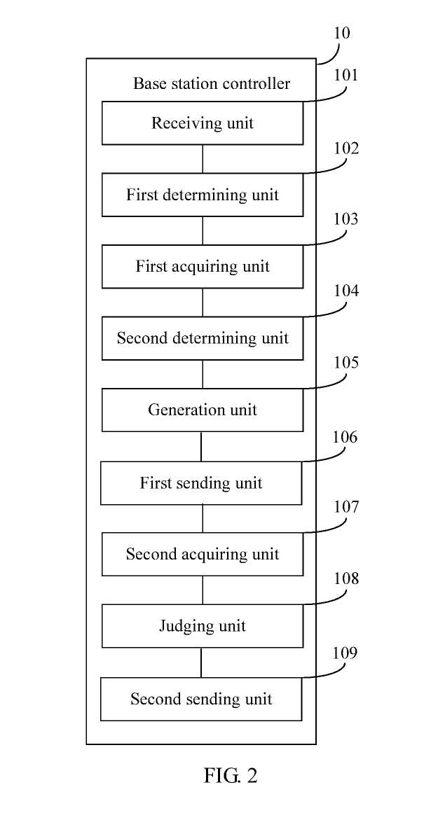

As shown in FIG. 2, the base station controller 10 further includes a second acquiring unit 107, configured to acquire a total quantity of the all active user equipment a judging unit 108, configured to determine whether the total quantity of the all active user equipment is 0, and a second sending unit 109, configured to: if the total quantity of the all active user equipment is 0, send, to the base station antenna, a disabling indication used to instruct to disable all access antennas in the first sector.

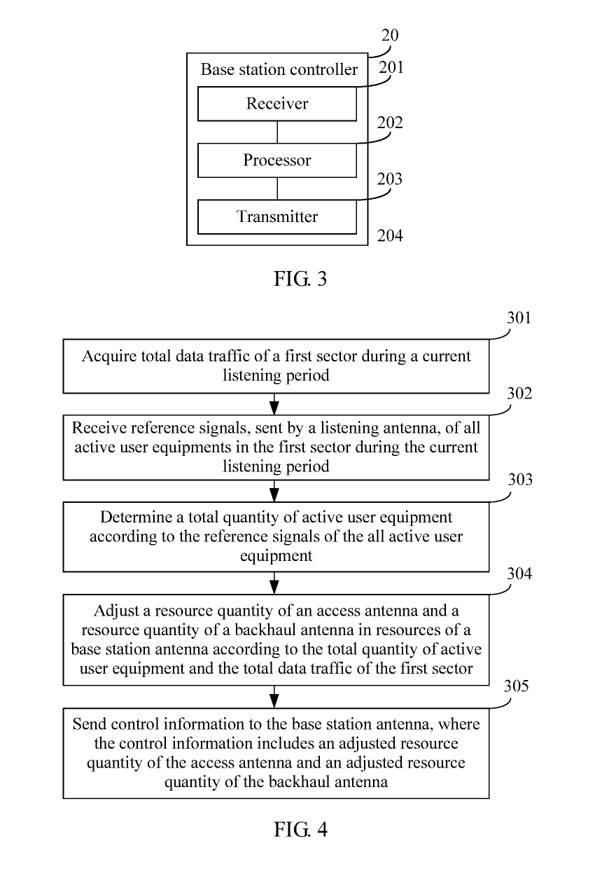

As shown in FIG. 3, an embodiment of the present disclosure provides a base station controller 20, including: a receiver 201, a processor 202, and a transmitter 203.

The receiver 201 is configured to receive reference signals sent by all active user equipment in a first sector during a current listening period, where the first sector is any sector of a base station antenna in a base station in which the base station controller is located and the processor 202 is configured to determine the all active user equipment according to the reference signals.

The processor 202 is further configured to acquire total data traffic of the first sector during the current listening period according to the all active user equipment.

The processor 202 is further configured to determine a to-be-adjusted resource quantity of an access antenna and a to-be-adjusted resource quantity of a backhaul antenna in resources of the base station antenna according to the total data traffic of the first sector during the current listening period.

A parameter of a listening antenna is preset by the base station controller, and the parameter of the listening antenna includes a beam width, a beam angle, a listening period, and listening time that are of the listening antenna.

The processor 202 is further configured to generate control information, where the control information includes the to-be-adjusted resource quantity of the access antenna and the to-be-adjusted resource quantity of the backhaul antenna.

The transmitter 203 is configured to send the control information to the base station antenna, where the control information includes the to-be-adjusted resource quantity of the access antenna and the to-be-adjusted resource quantity of the backhaul antenna, so that the base station antenna adjusts a resource of the access antenna and a resource of the backhaul antenna according to the control information.

In this way, a base station console may adjust a resource quantity of the access antenna and a resource quantity of the backhaul antenna according to a total quantity of active user equipment during the current listening period and the total data traffic of the first sector during the current listening period, which improves resource utilization of the base station antenna and saves resources of the base station.

It should be noted that the initial resources of the base station antenna are allocated according to a preset proportion of the access antenna, the backhaul antenna, and the listening antenna. Each base station antenna can allocate resources to both an access antenna and a backhaul antenna, instead of only the access antenna or the backhaul antenna. Therefore, resources of the base station antenna are saved, and the access antenna and the backhaul antenna are located at a same base station, which implements integration of the base station antenna.

The processor 202 is further configured to acquire preset average data traffic of the first sector, determine whether the total data traffic of the first sector during the current listening period is greater than the preset average data traffic of the first sector, acquire a preset peak value of the first sector if the total data traffic of the first sector during the current listening period is greater than the preset average data traffic of the first sector, determine whether the total data traffic of the first sector during the current listening period is greater than the preset peak value of the first sector, acquire total data traffic of the first sector during a previous listening period if the total data traffic of the first sector during the current listening period is greater than the preset peak value of the first sector, determine whether the total data traffic of the first sector during the previous listening period is greater than the preset peak value of the first sector, and send a cooperative work request to another base station if the total data traffic of the first sector during the previous listening period is less than or equal to the preset peak value of the first sector, so that the another base station performs information transmission with user equipment in the first sector according to the cooperative work request.

Further, the processor 202 is further configured to acquire the total data traffic of the first sector during the previous listening period if the total data traffic of the first sector during the current listening period is less than or equal to the preset peak value of the first sector, determine whether the total data traffic of the first sector during the previous listening period is greater than the preset peak value of the first sector, if the total data traffic of the first sector during the previous listening period is greater than the preset peak value of the first sector, send a cooperative stop request to another base station, so that the another base station stops performing information transmission with user equipment in the first sector according to the cooperative stop request, obtain a corresponding to-be-decreased resource quantity of the backhaul antenna and a corresponding to-be-increased resource quantity of the access antenna according to a traffic difference between the total data traffic of the first sector during the current listening period and the preset average data traffic of the first sector, and if the total data traffic of the first sector during the previous listening period is less than or equal to the preset peak value of the first sector, obtain a corresponding to-be-decreased resource quantity of the backhaul antenna and a corresponding to-be-increased resource quantity of the access antenna according to a traffic difference between the total data traffic of the first sector during the current listening period and the preset average data traffic of the first sector.

Further, the processor 202 is further configured to if the total data traffic of the first sector during the current listening period is less than or equal to the preset average data traffic of the first sector, obtain a corresponding to-be-increased resource quantity of the backhaul antenna and a corresponding to-be-decreased resource quantity of the access antenna according to a traffic difference between the total data traffic of the first sector during the current listening period and the preset average data traffic of the first sector.

As shown in FIG. 3, the base station controller 20 further includes:

The processor 202 can be can be configured to acquire a total quantity of the all active user equipment.

The processor 202 can be further configured to determine whether the total quantity of the all active user equipment is 0.

The transmitter 203 can be further configured to: if the total quantity of the all active user equipment is 0, send, to the base station antenna, a disabling indication used to instruct to disable all access antennas in the first sector.

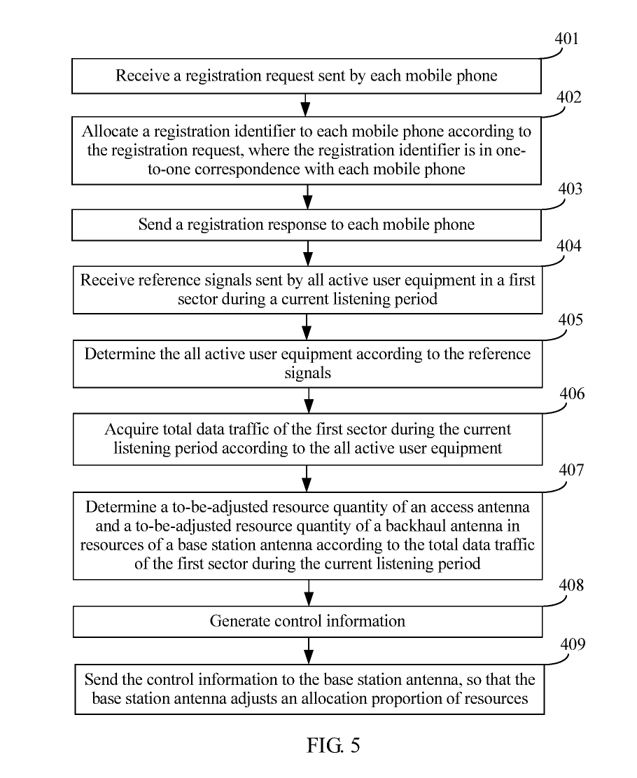

An embodiment of the present disclosure provides a resource allocation method applied to a base station controller, and as shown in FIG. 4. Step 301: Receive reference signals sent by all active user equipment in a first sector during a current listening period, where the first sector is any sector of a base station antenna in a base station in which the base station controller is located.

A listening antenna is configured to: receive a reference signal sent by active user equipment and send the reference signal to the base station controller. A parameter of the listening antenna is preset by the base station controller, and the parameter of the listening antenna includes a beam width, a beam angle, a listening period, and listening time that are of the listening antenna. The active user equipment is user equipment that performs a data service with the base station, and silent user equipment is user equipment that has a capability to perform a data service with the base station but does not perform the data service.

Step 302: Determine the all active user equipment according to the reference signals.

Step 303: Acquire total data traffic of the first sector during the current listening period according to the all active user equipment.

Step 304: Determine a to-be-adjusted resource quantity of an access antenna and a to-be-adjusted resource quantity of a backhaul antenna in resources of the base station antenna according to the total data traffic of the first sector during the current listening period.

Step 305: Generate control information, where the control information includes the to-be-adjusted resource quantity of the access antenna and the to-be-adjusted resource quantity of the backhaul antenna.

Step 306: Send the control information to the base station antenna.

It should be noted that, before a resource quantity of the access antenna and a resource quantity of the backhaul antenna are adjusted, the resources of the antenna are allocated according to a preset proportion of the access antenna, the backhaul antenna, and the listening antenna.

In this way, a base station console may adjust the resource quantity of the access antenna and the resource quantity of the backhaul antenna according to a total quantity of active user equipment during the current listening period and the total data traffic of the first sector during the current listening period, which improves resource utilization of the base station antenna and saves resources of the base station.

Before step 301, the resource allocation method further includes the following: The base station controller receives a registration request sent by first user equipment, where the first user equipment is any one of all unregistered user equipment; allocates a registration identifier to the first user equipment according to the registration request, where the registration identifier is in one-to-one correspondence with the first user equipment; and sends registration response information to the first user equipment, where the registration response information includes the registration identifier.

Further, step 304 that determine a to-be-adjusted resource quantity of an access antenna and a to-be-adjusted resource quantity of a backhaul antenna in resources of the base station antenna according to a total quantity of the active user equipment and the total data traffic of the first sector includes the following:

The base station controller may acquire preset average data traffic of the first sector; determine whether the total data traffic of the first sector during the current listening period is greater than the preset average data traffic of the first sector; acquire a preset peak value of the first sector if the total data traffic of the first sector during the current listening period is greater than the preset average data traffic of the first sector; and determine whether the total data traffic of the first sector during the current listening period is greater than the preset peak value of the first sector.

The base station controller acquires total data traffic of the first sector during a previous listening period if the total data traffic of the first sector during the current listening period is greater than the preset peak value of the first sector; determines whether the total data traffic of the first sector during the previous listening period is greater than the preset peak value of the first sector; and sends a cooperative work request to another base station if the total data traffic of the first sector during the previous listening period is less than or equal to the preset peak value of the first sector, so that the another base station performs information transmission with user equipment in the first sector according to the cooperative work request.

The base station controller acquires the total data traffic of the first sector during the previous listening period if the total data traffic of the first sector during the current listening period is less than or equal to the preset peak value of the first sector; determines whether the total data traffic of the first sector during the previous listening period is greater than the preset peak value of the first sector; if the total data traffic of the first sector during the previous listening period is greater than the preset peak value of the first sector, sends a cooperative stop request to another base station, so that the another base station stops performing information transmission with user equipment in the first sector according to the cooperative stop request; obtains a corresponding to-be-decreased resource quantity of the backhaul antenna and a corresponding to-be-increased resource quantity of the access antenna according to a traffic difference between the total data traffic of the first sector during the current listening period and the preset average data traffic of the first sector; and if the total data traffic of the first sector during the previous listening period is less than or equal to the preset peak value of the first sector, obtains a corresponding to-be-decreased resource quantity of the backhaul antenna and a corresponding to-be-increased resource quantity of the access antenna according to a traffic difference between the total data traffic of the first sector during the current listening period and the preset average data traffic of the first sector.

After the determining whether the total data traffic of the first sector during the current listening period is greater than the preset average data traffic of the first sector, the resource allocation method further includes: if the total data traffic of the first sector during the current listening period is less than or equal to the preset average data traffic of the first sector, obtaining a corresponding to-be-increased resource quantity of the backhaul antenna and a corresponding to-be-decreased resource quantity of the access antenna according to a traffic difference between the total data traffic of the first sector during the current listening period and the preset average data traffic of the first sector.

Used to determine the all active user equipment according to the reference signals, the resource allocation method further includes: acquiring a total quantity of the all active user equipment; determining whether the total quantity of the all active user equipment is 0; and if the total quantity of the all active user equipment is 0, sending, to the base station antenna, a disabling indication used to instruct to disable all access antennas in the first sector.

Before the to-be-adjusted resource quantity of the access antenna and the to-be-adjusted resource quantity of the backhaul antenna are determined in the resources of the base station antenna according to the total data traffic of the first sector during the current listening period, the initial resources of the base station antenna are allocated according to a preset proportion of the access antenna, the backhaul antenna, and the listening antenna. Each base station antenna can allocate resources to both an access antenna and a backhaul antenna, instead of only the access antenna or the backhaul antenna. Therefore, resources of the base station antenna are saved, and the access antenna and the backhaul antenna are located at a same base station, which implements integration of the base station antenna.

An embodiment of the present disclosure provides a resource allocation method applied to a base station controller. In this embodiment, that a base station starts working is used as an example, it is assumed that user equipment are mobile phones, and the mobile phones include an active mobile phone and a silent mobile phone. Specific steps are shown in FIG. 5, including:

Step 401: Receive a registration request sent by each mobile phone.

Because the base station controller cannot directly receive external information, a base station antenna receives the registration request and then sends the registration request to the base station controller.

Step 402: Allocate a registration identifier to each mobile phone according to the registration request, where the registration identifier is in one-to-one correspondence with the each mobile phone.

Step 403: Send a registration response to each mobile phone.

The registration response carries a registration identifier of a mobile phone, and the base station controller sends the registration response to the corresponding mobile phone by using the base station antenna.

Step 404: Receive reference signals sent by all active mobile phones in a first sector during a current listening period.

Specifically, for reference signals of all active mobile phones in the first sector sent by a listening antenna during the current listening period, the listening antenna sends the reference signals to the base station controller, where the reference signals of the active mobile phones are received by using a listening antenna. A parameter of the listening antenna is preset by the base station controller, and the parameter of the listening antenna includes a beam width, a beam angle, a listening period, and listening time that are of the listening antenna.

Step 405: Determine the all active mobile phones according to the reference signals.

Specifically, an active mobile phone may receive a signal of a wireless local area network hotspot to obtain signal strength of the wireless local area network hotspot, and sends the signal strength, used as a reference signal, to the base station controller. The base station controller may obtain a distance from a position of the mobile phone to a transmit end of the wireless local area network hotspot according to contrast calculation between the signal strength and preset signal strength of the wireless local area network hotspot. If there are multiple transmit ends of wireless local area network hotspots, a distance from the mobile phone to each transmit end may be obtained. Then, position coordinates of the active mobile phone are calculated according to position coordinates of each transmit end of the wireless local area network hotspots. A range of the first sector is acquired, and it is determined whether the position coordinates of the active mobile phone are within the range of the first sector, where the active mobile phone is an active mobile phone in the first sector. It should be noted that there are still various methods for obtaining a position of the active mobile phone in the first sector in the present disclosure, for example, a direction of arrival estimation method.

Step 406: Acquire total data traffic of the first sector during the current listening period according to the all active mobile phones.

Step 407: Determine a to-be-adjusted resource quantity of an access antenna and a to-be-adjusted resource quantity of a backhaul antenna in resources of a base station antenna according to the total data traffic of the first sector during the current listening period.

Specifically, the base station controller first acquires preset average data traffic of the first sector and then determines whether the total data traffic of the first sector during the current listening period is greater than the preset average data traffic of the first sector. If the total data traffic of the first sector during the current listening period is greater than the preset average data traffic of the first sector, the base station controller first acquires a preset peak value of the first sector and then determines whether the total data traffic of the first sector during the current listening period is greater than the preset peak value of the first sector.

If the total data traffic of the first sector during the current listening period is greater than the preset peak value of the first sector, the base station controller may acquire total data traffic of the first sector during a previous listening period and determine whether the total data traffic of the first sector during the previous listening period is greater than the preset peak value. If data traffic of the first sector during the previous listening period is less than or equal to the preset peak value, the base station controller may send a cooperative work request to another base station, so that the another base station performs information transmission with a mobile phone in the first sector according to the cooperative work request. Specifically, the base station controller calculates a difference between the total data traffic of the first sector during the current listening period and the preset peak value of the first sector, so as to obtain a traffic difference, and selects, according to the traffic difference, one or more suitable base stations for scheduling. A resource allocation method of another base station is the same as that of the base station.

If the total data traffic of the first sector during the current listening period is less than or equal to the preset peak value of the first sector, the base station controller may acquire the total data traffic of the first sector during the previous listening period and then determine whether data traffic during the previous listening period is greater than the preset peak value of the first sector. If the data traffic during the previous listening period is greater than the preset peak value of the first sector, the base station controller sends a cooperative stop request to another base station, so that the another base station stops performing information transmission with a mobile phone in the first sector according to the cooperative stop request. The total data traffic of the first sector during the current listening period and the preset average data traffic of the first sector are compared to obtain a traffic difference. A resource quantity of resources is obtained according to the traffic difference, and then a corresponding to-be-increased resource quantity of the access antenna and a corresponding to-be-decreased resource quantity of the backhaul antenna are obtained. If the data traffic during the previous listening period is less than or equal to the preset peak value of the first sector, the total data traffic of the first sector during the current listening period and the preset average data traffic of the first sector are compared to obtain a traffic difference. A resource quantity of resources is obtained according to the traffic difference, and then a corresponding to-be-increased resource quantity of the access antenna and a corresponding to-be-decreased resource quantity of the backhaul antenna are obtained.

If the total data traffic of the first sector during the current listening period is less than or equal to the preset average data traffic of the first sector, a corresponding to-be-increased resource quantity of the backhaul antenna and a corresponding to-be-decreased resource quantity of the access antenna are obtained according to a traffic difference between the total data traffic of the first sector during the current listening period and the preset average data traffic of the first sector.

Step 408: Generate control information.

The control information includes a corresponding to-be-increased resource quantity of the backhaul antenna and a corresponding to-be-decreased resource quantity of the access antenna; or a corresponding to-be-decreased resource quantity of the backhaul antenna and a corresponding to-be-increased resource quantity of the access antenna.

Step 409: Send the control information to the base station antenna, so that the base station antenna adjusts an allocation proportion of resources.

For example, it is assumed that a football field that can accommodate twenty thousand people exists in a cell range corresponding to the first sector. When a football match is held, a quantity of people in the first sector during a current listening period increases explosively, and the base station controller may acquire total data traffic of the first sector during the current listening period, acquire a preset average data traffic of the first sector, and acquire a preset peak value of the first sector. If the total data traffic of the first sector during the current listening period is greater than the preset average data traffic, the base station controller determines whether the total data traffic of the first sector during the current listening period is greater than the preset peak value of the first sector. If the total data traffic of the first sector during the current listening period is greater than the preset peak value of the first sector, the base station controller acquires total data traffic of the first sector during a previous listening period. If the total data traffic of the first sector during the previous listening period is less than or equal to data traffic of a first listening period, the base station controller sends a cooperative work request to another base station. When the football match is over, the base station controller may acquire total data traffic of the first sector during a current listening period and acquire the preset average data traffic of the first sector. If the total data traffic of the first sector during the current listening period is greater than the preset average data traffic, the base station controller determines whether the total data traffic of the first sector during the current listening period is greater than the preset peak value of the first sector. If the total data traffic of the first sector during the current listening period is not greater than the preset peak value of the first sector, the base station controller acquires total data traffic of the first sector during a previous listening period, and determines whether the total data traffic of the first sector during the previous listening period is greater than the data traffic of the first listening period. If the total data traffic of the first sector during the previous listening period is greater than the data traffic of the first listening period, the base station controller sends a cooperative stop request to another base station, and adjusts resources of the base station antenna according to a difference between the total data traffic of the first sector during the current listening period and the preset peak value. An hour later after the match is over, people in the football field are increasingly fewer. The base station controller may acquire total data traffic of the first sector during a current listening period and acquire the preset average data traffic of the first sector. If the total data traffic of the first sector during the current listening period is less than or equal to the preset average data traffic, the base station controller adjusts the resources of the base station antenna, so as to increase a corresponding resource quantity of the backhaul antenna, and decrease a corresponding resource quantity of the access antenna. When the football field is closed, there is no active mobile phone in the first sector, and the base station controller sends, to the base station antenna, a disabling indication used to instruct to disable an access antenna corresponding to the first sector.

The embodiments of the present disclosure provide a resource acquiring method and a base station controller. The method includes: receiving reference signals sent by all active user equipment in a first sector during a current listening period, where the first sector is any sector of a base station antenna in a base station in which the base station controller is located; determining the all active user equipment according to the reference signals; acquiring total data traffic of the first sector during the current listening period according to the all active user equipment; determining a to-be-adjusted resource quantity of an access antenna and a to-be-adjusted resource quantity of a backhaul antenna in resources of the base station antenna according to the total data traffic of the first sector during the current listening period; generating control information, where the control information includes the to-be-adjusted resource quantity of the access antenna and the to-be-adjusted resource quantity of the backhaul antenna; and sending the control information to the base station antenna. In this way, a base station console may adjust a resource quantity of the access antenna and a resource quantity of the backhaul antenna according to a total quantity of active user equipment during the current listening period and the total data traffic of the first sector during the current listening period, which improves resource utilization of the base station antenna and saves resources of the base station.

A person of ordinary skill in the art may understand that all or some of the steps of the method embodiments may be implemented by a program instructing relevant hardware. The program may be stored in a computer-readable storage medium. When the program runs, the steps of the method embodiments are performed. The foregoing storage medium includes: any medium that can store program code, such as a ROM, a RAM, a magnetic disk, or an optical disc.

It should be noted that a sequence of the steps of the resource allocation method provided in the embodiments of the present disclosure may be adjusted properly, and the steps may also be added or removed according to conditions. Any changed method readily figured out by a person skilled in the art within the technical scope disclosed in the present disclosure shall fall within the protection scope of the present disclosure, and therefore, details are not described again.

The foregoing descriptions are merely specific implementation manners of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

What is claimed is:

1. A base station controller, comprising:
a receiver that receives reference signals sent by all active user equipment in a first sector during a current listening period, wherein the first sector is any sector of a base station antenna in a base station in which the base station controller is located;
a processor coupled to the receiver that determines the all active user equipment according to the reference signals, acquires total data traffic of the first sector during the current listening period according to the all active user equipment, determines a to-be-adjusted resource quantity of an access antenna and a to-be-adjusted resource quantity of a backhaul antenna in resources of the base station antenna according to the total data traffic of the first sector during the current listening period, generates control information, wherein the control information comprises the to-be-adjusted resource quantity of the access antenna and the to-be-adjusted resource quantity of the backhaul antenna; and
a transmitter coupled to the processor that sends the control information to the base station antenna, so that the base station antenna adjusts a resource of the access antenna and a resource of the backhaul antenna according to the control information.

2. The base station controller according to claim 1, wherein an initial resources of the base station antenna are allocated according to a preset proportion of the access antenna, the backhaul antenna, and a listening antenna.

3. The base station controller according to claim 2, wherein a parameter of the listening antenna is preset by the base station controller, and the parameter of the listening antenna comprises at least one of: a beam width, a beam angle, a listening period, and listening time that are of the listening antenna.

4. The base station controller according to claim 3, wherein the processor further acquires preset average data traffic of the first sector, determines whether the total data traffic of the first sector during the current listening period is greater than the preset average data traffic of the first sector, acquires a preset peak value of the first sector if the total data traffic of the first sector during the current listening period is greater than the preset average data traffic of the first sector, determines whether the total data traffic of the first sector during the current listening period is greater than the preset peak value of the first sector, acquires total data traffic of the first sector during a previous listening period if the total data traffic of the first sector during the current listening period is greater than the preset peak value of the first sector, determines whether the total data traffic of the first sector during the previous listening period is greater than the preset peak value of the first sector, and sends a cooperative work request to another base station if the total data traffic of the first sector during the previous listening period is less than or equal to the preset peak value of the first sector, so that the another base station performs information transmission with user equipment in the first sector according to the cooperative work request.

5. The base station controller according to claim 4, wherein the processor further acquires the total data traffic of the first sector during the previous listening period if the total data traffic of the first sector during the current listening period is less than or equal to the preset peak value of the first sector, determines whether the total data traffic of the first sector during the previous listening period is greater than the preset peak value of the first sector, if the total data traffic of the first sector during the previous listening period is greater than the preset peak value of the first sector, send a cooperative stop request to another base station, so that the another base station stops performing information transmission with user equipment in the first sector according to the cooperative stop request, obtains a corresponding to-be-decreased resource quantity of the backhaul antenna and a corresponding to-be-increased resource quantity of the access antenna according to a traffic difference between the total data traffic of the first sector during the current listening period and the preset average data traffic of the first sector and if the total data traffic of the first sector during the previous listening period is less than or equal to the preset peak value of the first sector, obtains a corresponding to-be-decreased resource quantity of the backhaul antenna and a corresponding to-be-increased resource quantity of the access antenna according to a traffic difference between the total data traffic of the first sector during the current listening period and the preset average data traffic of the first sector.

6. The base station controller according to claim 4, wherein the processor determines if the total data traffic of the first sector during the current listening period is less than or equal to the preset average data traffic of the first sector and obtains a corresponding to-be-increased resource quantity of the backhaul antenna and a corresponding to-be-decreased resource quantity of the access antenna according to a traffic difference between the total data traffic of the first sector during the current listening period and the preset average data traffic of the first sector.

7. The base station controller according to claim 6, wherein the processor acquires a total quantity of the all active user equipment, determines whether the total quantity of the all active user equipment is 0, determines that the total quantity of the all active user equipment is 0, and sends, to the base station antenna, a disabling indication used to instruct to disable all access antennas in the first sector.

8. A resource allocation method wherein the method comprises:
receiving reference signals, by a base station, sent by all active user equipment in a first sector during a current listening period, wherein the first sector is any sector of a base station antenna in a base station in which the base station controller is located;
determining, by a base station, the all active user equipment according to the reference signals;
acquiring, by a base station, total data traffic of the first sector during the current listening period according to the all active user equipment;
determining, by a base station, a to-be-adjusted resource quantity of an access antenna and a to-be-adjusted resource quantity of a backhaul antenna in resources of the base station antenna according to the total data traffic of the first sector during the current listening period;
generating, by a base station, control information, wherein the control information comprises the to-be-adjusted resource quantity of the access antenna and the to-be-adjusted resource quantity of the backhaul antenna; and
sending, by a base station, the control information to the base station antenna, wherein the control information comprises the to-be-adjusted resource quantity of the access antenna and the to-be-adjusted resource quantity of the backhaul antenna, so that the base station antenna adjusts a resource of the access antenna and a resource of the backhaul antenna according to the control information.

9. The resource allocation method according to claim 8, wherein before the determining a to-be-adjusted resource quantity of an access antenna and a to-be-adjusted resource quantity of a backhaul antenna in resources of the base station antenna according to the total data traffic of the first sector during the current listening period, an initial resources of the base station antenna are allocated according to a preset proportion of the access antenna, the backhaul antenna, and a listening antenna.

10. The resource allocation method according to claim 9, wherein a parameter of the listening antenna is preset by the base station controller, and the parameter of the listening antenna comprises a beam width, a beam angle, a listening period, and listening time that are of the listening antenna.

11. The resource allocation method according to claim 10, wherein the determining a to-be-adjusted resource quantity of an access antenna and a to-be-adjusted resource quantity of a backhaul antenna in resources of the base station antenna according to the total data traffic of the first sector during the current listening period comprises:
acquiring preset average data traffic of the first sector;
determining whether the total data traffic of the first sector during the current listening period is greater than the preset average data traffic of the first sector;
acquiring a preset peak value of the first sector if the total data traffic of the first sector during the current listening period is greater than the preset average data traffic of the first sector;
determining whether the total data traffic of the first sector during the current listening period is greater than the preset peak value of the first sector;
acquiring total data traffic of the first sector during a previous listening period if the total data traffic of the first sector during the current listening period is greater than the preset peak value of the first sector;
determining whether the total data traffic of the first sector during the previous listening period is greater than the preset peak value of the first sector; and
sending a cooperative work request to another base station if the total data traffic of the first sector during the previous listening period is less than or equal to the preset peak value of the first sector, so that the another base station performs information transmission with user equipment in the first sector according to the cooperative work request.

12. The resource allocation method according to claim 11, wherein after the determining whether the total data traffic of the first sector during the current listening period is greater than the preset peak value of the first sector,
the determining a to-be-adjusted resource quantity of an access antenna and a to-be-adjusted resource quantity of a backhaul antenna in resources of the base station antenna according to the total data traffic of the first sector during the current listening period,further comprises:
acquiring the total data traffic of the first sector during the previous listening period if the total data traffic of the first sector during the current listening period is less than or equal to the preset peak value of the first sector;
determining whether the total data traffic of the first sector during the previous listening period is greater than the preset peak value of the first sector;
if the total data traffic of the first sector during the previous listening period is greater than the preset peak value of the first sector, sending a cooperative stop request to another base station, so that the another base station stops performing information transmission with user equipment in the first sector according to the cooperative stop request;
obtaining a corresponding to-be-decreased resource quantity of the backhaul antenna and a corresponding to-be-increased resource quantity of the access antenna according to a traffic difference between the total data traffic of the first sector during the current listening period and the preset average data traffic of the first sector; and
if the total data traffic of the first sector during the previous listening period is less than or equal to the preset peak value of the first sector, obtaining a corresponding to-be-decreased resource quantity of the backhaul antenna and a corresponding to-be-increased resource quantity of the access antenna according to a traffic difference between the total data traffic of the first sector during the current listening period and the preset average data traffic of the first sector.

13. The resource allocation method according to claim 11, wherein after the determining whether the total data traffic of the first sector during the current listening period is greater than the preset average data traffic of the first sector, the resource allocation method further comprises:
if the total data traffic of the first sector during the current listening period is less than or equal to the preset average data traffic of the first sector, obtaining a corresponding to-be-increased resource quantity of the backhaul antenna and a corresponding to-be-decreased resource quantity of the access antenna according to a traffic difference between the total data traffic of the first sector during the current listening period and the preset average data traffic of the first sector.

14. The resource allocation method according to claim 13, wherein after the determining the all active user equipment according to the reference signals, the resource allocation method further comprises:
acquiring a total quantity of the all active user equipment;
determining whether the total quantity of the all active user equipment is 0; and
if the total quantity of the all active user equipment is 0, sending, to the base station antenna, a disabling indication used to instruct to disable all access antennas in the first sector.
